(19) United States
(12) Patent Application Publication
(10) Pub. No.: US 2016/0027468 A1
(43) Pub. Date: Jan. 28, 2016

(54) CHANNEL BITWORD PROSESSOR, PRML DECODER, AND OPTICAL INFORMATION RECORDING/REPRODUCING DEVICE

(71) Applicant: Hitachi-LG Data Storage, Inc., Tokyo (JP)

(72) Inventor: Atsushi KIKUGAWA, Tokyo (JP)

(21) Appl. No.: 14/753,345

(22) Filed: Jun. 29, 2015

(30) Foreign Application Priority Data
Jul. 25, 2014 (JP) 2014-152209

(51) Int. Cl. G11B 20/12

(52) U.S. Cl. CPC G11B 20/1217

(57) ABSTRACT

It is an objective of the present invention to provide a technique to balance DSV in channel bit word when using fixed-length run length limited code based on enumeration. A channel bit word processor according to the present invention: evaluates DSV of a channel bit word in NRZI format which is generated on the basis of enumeration; and selects a connection word which causes a minimum absolute value of DSV after connecting a plurality of channel bit words (refer to FIG. 15).

### CLAIM OF PRIORITY

The present application claims priority from Japanese patent application JP 2014-152209 filed on Jul. 25, 2014, the content of which is hereby incorporated by reference into this application.

### BACKGROUND

1. Technical Field

The present invention relates to a technique for recording information using light.

2. Background Art

Parts of technical terms in following descriptions are those used in Blu-ray Disc (BD). These terms are sometimes referred to as other words in systems other than BD. However, since those skilled in the art could readily understand such words, technical terms in BD system will be used below.

Storage capacities of optical discs have been expanded mainly by reducing wavelength of light sources, by increasing numerical apertures (NA) of objective lenses, and by increasing the number of recording layers per one disc. In dual layer BD systems, recording capacity of 50 GB have been achieved using blue semiconductor lasers and high NA objective lenses with NA of 0.85. However, reducing wavelengths of recording/reproducing light or increasing NA of objective lenses have almost reached their limits.

Under such circumstances, a possible method for further increasing recording capacity of optical discs may be to increase linear recording density by simply shrinking channel bit length, thereby increasing surface recording density. By increasing the number of recording layers up to 3-4 layers in addition to above, BDXL with recording capacity of more than 100 GB has been achieved. However, this method intensifies inter symbol interferences, thus reducing resolution of short marks or spaces. In BDXL, resolution of the minimum marks and spaces is 0. By further shrinking channel bit length, resolution of the second minimum marks and spaces will be 0. Those skilled in the art readily understand that decoding process of PRML method will not work under such configurations. In other words, this method has a limit in significantly improving recording density.

Another method for increasing recording capacity of optical discs is code modulation. A type of code modulation has already been used in BD or the like. It is expected that code modulation will achieve several advantageous effects. Improving linear recording density is one of the most expected effects among them. Run length limited code is known as one of methods used for that objective.

In optical discs, spot diameter of light used for reproduction is much larger than physical resolution of recording medium. Therefore, if binary data to be recorded (referred to as user data in this document) is recorded in association with existence/non-existence of recording mark, the margin between recorded bits may be smaller than the diameter of light spot. This drastically makes it difficult to recognize codes due to inter symbol interferences between adjacent bits. As a result, the resolution of recording medium cannot be utilized efficiently.

On the other hand, in run length limited code, user data is recorded after converting it into a code stream described by length of marks and spaces. Even if the unit length of marks and spaces (channel bit length) is smaller than the light spot diameter, it is possible to identify the lengths of marks and spaces in the temporal axis during reproduction. Note that the minimum marks and spaces have a length longer than 2 channel bits so that they can be reproduced with sufficient resolutions. In this way, it is possible to achieve a higher linear recording density than that of optical systems having the same special resolution.

When recording information using run length limited codes, it is principally appropriate to discuss lengths of both recorded marks and spaces. However, for the sake of simplifying descriptions, only marks will be discussed when handling recorded marks and spaces in the same way as long as no confusion will be incurred. For example, “resolution of the minimum mark” means “resolution of the minimum mark and space”.

Two types of run-length codes are known. The first one is fixed length code on the basis of enumeration. The second one is variable length code. The run length limited code used in BD, which is a current representative optical disc, is a variable length code with a minimum run length of 1. It achieves a linear recording density that is four-thirds times larger than that of without code modulation.

Non-Patent Document 1 listed below describes an algorithm to generate, while satisfying the minimum run-length limitation, fixed-length channel bit words corresponding to user bit words. Since those skilled in the art will readily understand the algorithm, its details will not be described in this document. With this algorithm, it is possible to mathematically calculate fixed-length channel bit words from given fixed-length user bit words (channel bit word generation). Similarly, from channel bit words, it is possible to calculate corresponding user data words using simple mathematic calculations (channel bit word demodulation).

### RELATED ART DOCUMENTS

### Non-Patent Documents

Non-Patent Document 1: IEEE TRANSACTIONS ON INFORMATION THEORY, VOL. 43, NO. 5, SEPTEMBER 1997

### SUMMARY

The method described in Non-Patent Document 1 generates channel bit words satisfying the run-length limitation. However, Non-Patent Literature 1 does not describe how to approximately balance the numbers of bits “0” and “1” (Digital Sum Value: DSV) appearing in channel bit data described in NRZI (Non Return to Zero Inverted) format along with the channel bit word generation.

The present invention is made in the light of the above-mentioned technical problem. It is an objective of the present invention to provide a technique to balance DSV in channel bit word when using fixed-length run length limited code based on enumeration.

A channel bit word processor according to the present invention: evaluates DSV of a channel bit word in NRZI format which is generated on the basis of enumeration; and selects a connection word which causes a minimum absolute value of DSV after connecting a plurality of channel bit words.

With the channel bit word processor according to the present invention, it is possible to generate fixed-length channel bit words satisfying maximum run-length limitation while balancing DSV of channel bit word, using simple configurations.

### BRIEF DESCRIPTION OF THE DRAWINGS

FIG. 1 is a diagram showing a recording/reproducing process of data.

FIG. 2 is a diagram showing a process of code modulation and demodulation.

FIG. 3 is a graph showing maximum Es for each case where d=1, 2, 3, 4 respectively.

FIG. 4 shows an example of pileup error observed in a reproduction simulation.

FIG. 5 is a graph showing an appearance frequency of edge numbers included in a pileup error observed in a simulation using (4, 21) PP shown in FIG. 4.

FIG. 6 shows a bit pattern example in which a pattern that is likely to incur pileup errors exists around a channel bit word boundary.

FIG. 7 shows a frame configuration example in which “1” is always used as a connection word.

FIG. 8 is a trellis diagram showing a decoding process using PRML method.

FIG. 9 is a block diagram of a PRML decoder 70 according to an embodiment 1.

FIG. 10 shows a simulation result of an example in which an error propagation at a channel bit word boundary is prohibited.

FIG. 11 shows a trellis diagram of the PRML decoder 70 around a fixed connection word when a constraint length is 5 and a minimum run-length is 1 (i.e. corresponding to the example of FIG. 10).

FIG. 12 is a diagram showing a frame configuration example using another connection word.

FIG. 13 shows a trellis diagram of the PRML decoder 70 when a constraint length is 5, a minimum run-length is 1, and a connection word is a zero unit 61.

FIG. 14 shows a simulation result of an example in which an error propagation at a channel bit word boundary is prohibited.

FIG. 15 is a diagram showing that paths and states on a trellis diagram are constrained according to type of connection word.

FIG. 16 is a diagram schematically showing a process where a connection word determinator 75 performs trace-back.

FIG. 17 is an operational flow chart of the connection word determinator 75.

FIG. 18 is an example of trellis diagram when constraint length of decoder is long.

FIG. 19 is a functional block diagram of a channel bit word processor 1900 according to the embodiment 1.

FIG. 20 is a configuration diagram of an optical disc device 100 according to an embodiment 3.

### DETAILED DESCRIPTION OF THE EMBODIMENTS

### Embodiment 1

In an embodiment 1 of the present invention, a configuration example will be described where an absolute value of DSV of channel bit words is made smaller as far as possible, while reducing burst errors. For the sake of convenience of description, recording/reproducing process of optical information and burst errors occurring in such process will be described first. Then a configuration will be described where DSV is made smaller as far as possible.

### Embodiment 1

### Regarding Recording/Reproducing Process of Optical Information

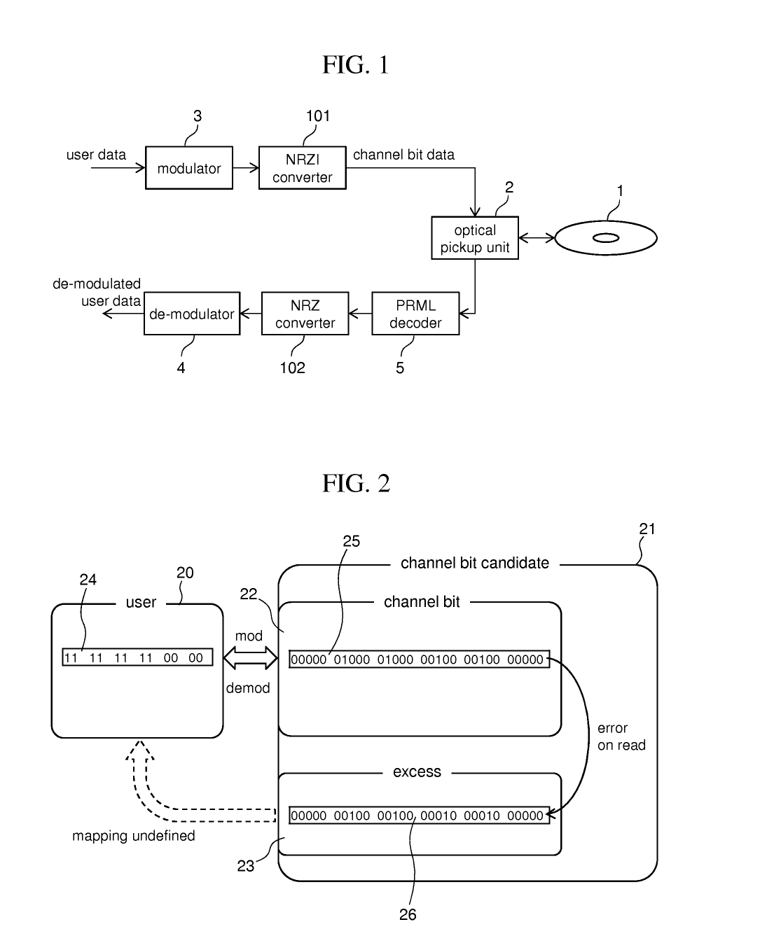

FIG. 1 is a diagram showing a recording/reproducing process of data. The figure is simplified by extracting portions required in the explanation only. The modulator 3 performs code modulation to user data using a predetermined code modulation scheme. The output from the modulator 3 is bit stream data of NRZ (Non return to Zero) format. In bit stream data of NRZ format, a bit corresponding to the mark boundary is expressed with “1”, and other bits are expressed with “0”. The NRZI converter 101 converts the output into NRZI format where “1” and “0” each corresponds to mark and space respectively. The optical pickup 2 records the signal into the optical disc 1.

When reproducing data, the optical pickup 2 optically reproduces the signal recorded in the optical disc 1 and converts it into electrical signals. Since the size of optical spot is finite, inter symbol interferences occur. The PRML decoder 5 decodes channel bit streams from the reproduction signal while resolving the inter symbol interferences. The NRZ converter 102 converts the decoded channel bit streams from NRZI format into NRZ format. The demodulator 4 demodulates the output from the NRZ converter 102 into binary data. If no error or time shift has occurred during the procedure above, the output from the demodulator 4 matches with the original user data.

FIG. 2 is a diagram showing a process of code modulation and demodulation. When modulating, the user bit stream 24 which is elements of the user bit stream set 20 is converted into the corresponding channel bit stream 25 in the channel bit stream set 22 in accordance with a conversion table. The user bit stream set and the channel bit stream set are coupled by one to one mapping. In other words, demodulation is an inverse mapping of modulation. In order to establish such code modulation, it is necessary that the size of channel bit stream candidate set is equal to or larger than that of user bit stream set. Typically, the channel bit stream candidate set is larger as shown in FIG. 2. Namely, there exists channel bit stream candidates (hereinafter, redundant bit stream 26) that are not included in the conversion table. The set which element is the redundant bit stream 26 is referred to as a redundant bit stream set 23. Accordingly, if an error occurs during the reproduction process as shown in the example of FIG. 2, the bit stream after reproduction may change into the redundant bit stream 26 due to the error. In such cases, since demodulation using the conversion table cannot be performed, exception handlings are required and thus the configuration of the demodulator becomes complicated. This applies to both of variable length code/fixed length code.

Code modulation achieves several functions such as an effect of improving linear recording density, an effect of preventing excessive continuation of 0 or 1, and the like. In optical discs, it is the most important to improve linear recording density using code modulations without shrinking spot diameters by limiting run-length in code modulation processes. 1-7PP code with minimum run-length of 1, which is used in BD, achieves a linear density that is four-third times larger than that of without code modulation.

A linear recording density improved ratio E using run length limited code is expressed by Equation 1 below. d and C are the minimum run-length and the capacity, respectively.

E=(d+1)C Equation 1)

C is expressed by Equation 2 below.

C=log₂λ (Equation 2)

λ is a maximum real root of the characteristic equation expressed by Equation 3 below. k is the maximum run length.

z^{k+2}−z^{k+1}−z^{k-d+1}+1=0 (Equation 3)

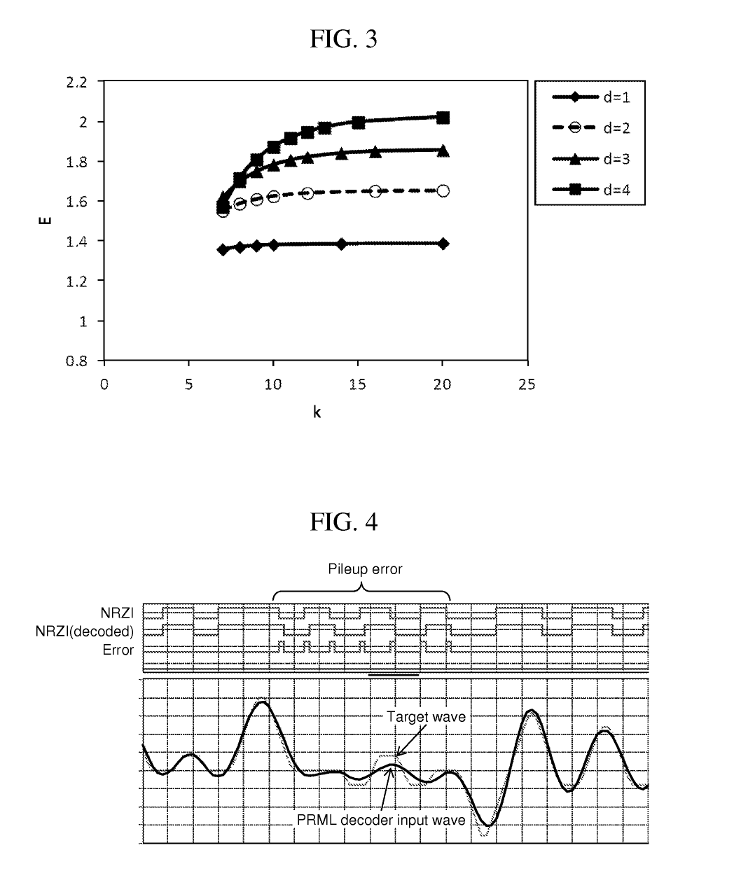

FIG. 3 is a graph showing a maximum Es for each case where d=1, 2, 3, 4 respectively. The value of E calculated by each of equations above is a theoretical value. In practically definable code modulations, its value is usually below the theoretical value.

Code modulation is a mapping in which mi bits of codes in a code stream set A are associated with ni bits of codes in a code stream set B on the one-by-one basis (m, n, i are natural numbers). Variable length code and fixed length code using enumeration are known as practical code modulations.

As described in Non-Patent Document 1, fixed length code modulation couples, via short connection words, channel bit words of fixed-length satisfying the run-length limitation selected according to user data. Each bit value in the connection words is selected so that channel bit words before and after the each bit value and the each bit value itself satisfy the run-length limitation.

Assuming that the length of the connection word is a, the effective linear recording density improved ratio E* of fixed-length code modulation is given by Equation 4 below.

E*={(d+1)m}/{n+a} (Equation 4)

### Embodiment 1

### Regarding Burst Error

In partial response systems, the smaller amplitude patterns are more likely to cause errors. Accordingly, if conventionally developed modulation codes are used, some measure is taken in typical cases so that the appearance frequency of minimum length marks is restricted up to a certain number. In addition, in partial response systems, it is likely that patterns with smaller Euclidean distance differences are more easily misrecognized. However, in a system where 2T marks with 0 resolution appear, such as BDXL, multiple patterns in which misrecognition cannot be negligible because of including 2T marks exist, even if Euclidean distance differences are large. Similar phenomenon occurs when the minimum run length d is made larger and the minimum mark length is approximately shrunk to the minimum mark length of BDXL. Further, if the minimum run length d is large, the resolution difference between the minimum mark length and the second minimum mark length is small. Therefore, complicated long pileup errors such as patterns including second shortest marks cause problems. Such pileup errors incur following problems.

(A) In regions where short marks consecutively appear, an error may trigger pileup errors with approximately the same length as that of the region. Thus the influence of the first error may be expanded.
(B) Since multiple edges simultaneously shift, channel bit patterns that are not included in the conversion table might appear causing demodulation errors.

FIG. 4 shows an example of pileup error observed in a reproduction simulation. Reproduction signals are calculated using convolution with respect to channel bit patterns based on optical responses calculated by optical simulations. In the channel bit patterns, (4, 21) PP code modulation described in “JP Patent Publication (Kokai) 2003-273743 A” is applied to random user bit word sequences. The calculation condition of optical responses is: spot light wavelength=405 nm; objective lens NA=0.85. The channel bit length is 22.3 nm. With such conditions, the minimum mark length is the same as the minimum mark length of BDXL. PR (1, 1, 1, 1, 1, 1, 1, 1, 1, 1, 1) ML is used for reproduction channels.

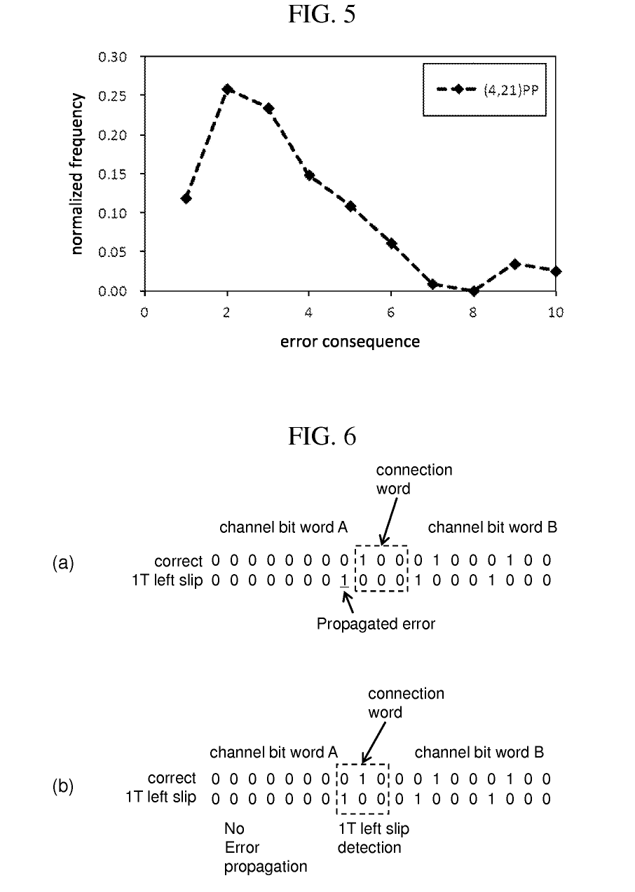

FIG. 5 is a graph showing an appearance frequency of edge numbers included in pileup errors observed in a simulation using (4, 21) PP shown in FIG. 4. The horizontal axis of the graph indicates the edge number included in the pileup error and corresponds to the length of the burst. In a case of single edge shift, its value is 1 and the shift of the minimum length mark is 2. As shown in FIG. 5, in (4, 21) PP, the ratio of single edge shift error is small and most of errors are pileup errors. An error in which the number of consecutive error is 2 can be most frequently observed.

In many cases of pileup errors, multiple edges simultaneously shift in the same direction. Thus in a case of variable length conversion, the recognition of channel bit word boundaries may not work. In variable length conversions, prefix pattern conditions are used in order to perform channel bit word boundary recognitions during demodulation. The prefix pattern condition is a condition where the beginning portion of channel bit patterns does not include channel bit patterns shorter than the condition.

However, if pileup error occurs, a prefix pattern is recognized as another pattern. As a result, the boundary of channel bit words becomes different from that of without errors. This misrecognized boundary is referred to as false channel bit word boundary. A channel bit word separated by a false channel bit word boundary is referred to as false channel bit word. Obviously, the demodulated result is different from that of without errors. These results are referred to as false user bit stream. The demodulation result with errors is problematic. More seriously, demodulation could be disabled because recognition of channel bit word boundaries fails and thus channel bit words that are not included in the conversion table appear. In such cases, exception handlings will be required. In addition, misrecognition of channel bit word boundaries propagates like a chain-reaction to cause demodulation errors in regions broader than those of pileup errors during decode process. For the sake of convenience, such misrecognition of channel bit word boundaries is referred to as boundary error. In addition, the phenomenon where boundary errors propagate subsequently is referred to as boundary error propagation, and the phenomenon where demodulation process cannot be continued is referred to as demodulation error.

In a case of fixed length modulation, no boundary propagation occurs because the channel bit word length is fixed. However, if there exists patterns that are likely to cause pileup errors around channel bit word boundaries, it is more likely that pileup errors occur at the region across the channel bit word boundary and that the error propagates into adjacent channel bit words. In addition, in fixed length modulations, the values of m and n are increased as far as possible in order to relatively decrease the influence of connection word sequence and to improve E*. In other words, the channel bit word length is made longer. Therefore, the influence is significant especially when the error propagates across the channel bit word boundary.

FIG. 6 shows a bit pattern example in which a pattern that is likely to incur pileup errors exists around a channel bit word boundary. FIG. 6(a) upper diagram shows a proper channel bit word sequence. FIG. 6(b) shows an example where an error propagates into an adjacent channel bit word due to a pileup error in which the pattern of FIG. 6(a) slips leftward by 1T. The bit stream surrounded by the dotted line is connection words. In FIG. 6(a) lower diagram, a bit “1” in the connection word is pushed toward the channel bit word A (underlined bit “1”) due to the pileup error of leftward 1T slip caused in the channel bit word B. Accordingly, the decode result of the channel bit word A also results in error.

In the example shown in FIG. 6(a), the connection word is selected according to conventional techniques. In conventional techniques, connection words may be arbitrarily selected within a range satisfying the run-length limitation considering preceding and subsequent channel bit words. Therefore, if “1” exists at the end of connection words, error propagation is likely to occur.

FIG. 6(b) shows an example where a fixed bit pattern “010” is used as the connection word, which is different from conventional techniques. FIG. 6(b) upper diagram shows a bit pattern example in which patterns that are likely to cause pileup errors exist around the channel bit word boundary. In FIG. 6(b) lower diagram, a bit “1” in the connection word is pushed leftward by 1T due to the pileup error of leftward 1T slip caused in the channel bit word B. However, since the error is within the connection word, there is no influence in the decode result of the channel bit word A. In this way, it is possible to prevent errors from propagating into adjacent channel bit words by always using specific bit patterns as connection words. In the example above, it is possible to selectively use “010” or “000” as connection words.

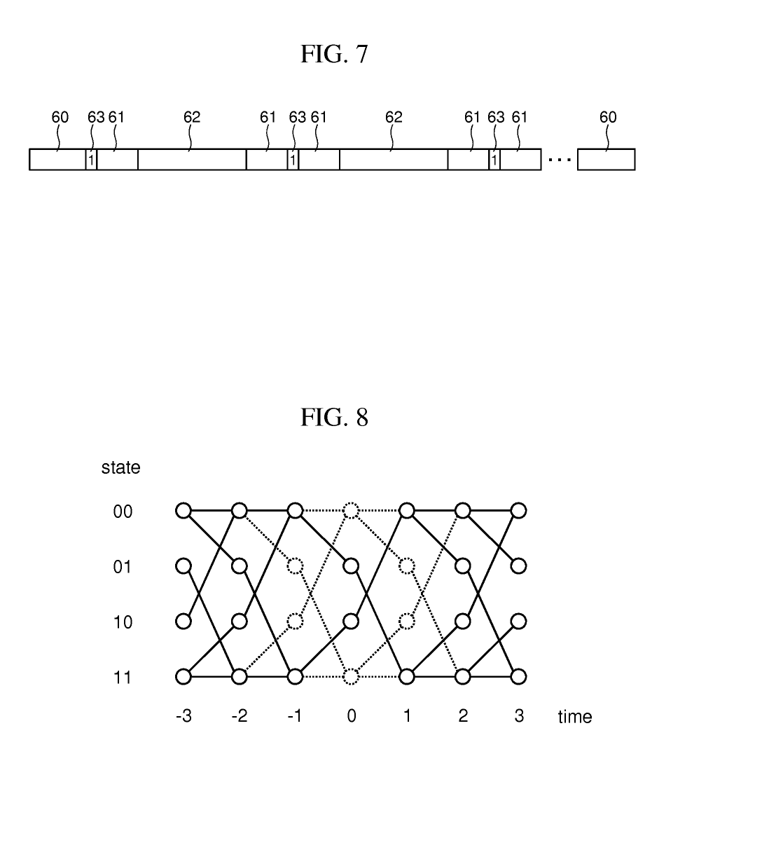

FIG. 7 shows a frame configuration example in which “1” is always used as a connection word. The connection word with fixed “1” is referred to as a fixed edge 63. The range of one frame is from the frame sync unit 60 to immediately before the frame sync unit 60 of the next frame. The channel bit word 62 is generated from user data using the above-described method. Due to the minimum run-length limitation, there are at least d bits of consecutive “0” before and after the fixed edge. In other words, the pattern is fixed for 2d+1 time units. These d bits of consecutive “0” are referred to as zero unit 61.

### Embodiment 1

### Regarding Restriction of Burst Error

If strong inter symbol interferences exist, it is effective to decode channel bits using PRML (Partial Response Maximum Likelihood) method. Assuming that known patterns appear at specific locations as mentioned above, it is possible to prevent error propagations into adjacent channel bit words as well as to improve decode performances around the position. Hereinafter, specific configurations of a decoder using PRML method will be described.

In order to improve decode performances using the frame configuration of FIG. 7, a special design is required in the PRML decoder. In other words, it is necessary to change the calculation method of branch metrics in the ACS (Add Compare Select) unit of the PRML decoder in synchronization with the timing when the fixed patterns appear. The process will be described using a trellis diagram.

FIG. 8 is a trellis diagram showing a decoding process using PRML method. For the sake of simplification, an example is shown where the constraint length is 3 and the minimum run-length is 1. FIG. 8 shows how to calculate a branch metric of each time using a trellis diagram around the fixed connection word shown in FIG. 7. The values below the trellis diagram are times based on the appearance time (=0) of the fixed connection word as the reference time. The states represented by dotted lines are states that are not required to be considered in decode process because the pattern has already been determined by the fixed connection word. In other words, these patterns may be handled as invalid. The branches represented by dotted lines are branches that are not required to be considered in decode process because these branches come from or end at invalid states. In other words, these branches may be handled as invalid.

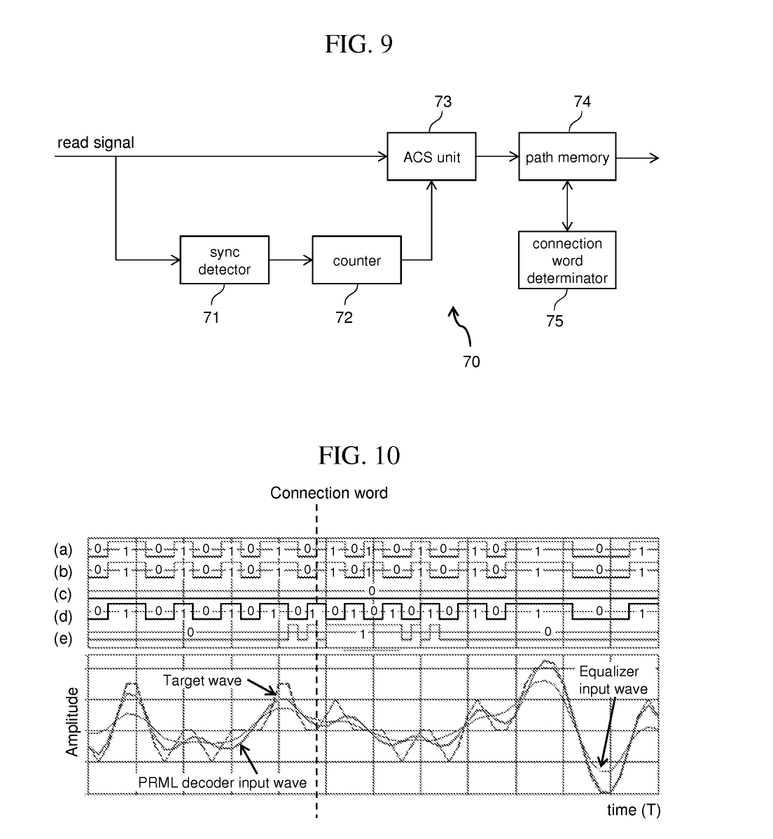

The ACS process is different whether it is concerned with invalid states or branches or not. As in the state “00” at time 1, when a state is valid but one of branches extended from the preceding time (time 0) is invalid, consequently the other valid branch is selected. Thus the path memory 74 (described in FIG. 9 later) stores the state that will be a start point of valid branch. The branch metric calculated for valid branches can be added to the path metric of preceding times to generate a new path metric. As in the state “00” at time 0, when the state is invalid, the path memory 74 stores a value indicating an invalid state. Accordingly, if path merge is performed using trace back scheme, trace back will not be performed for paths where a value indicating invalid state is set at the beginning of trace back.

It is required to perform the above-described procedure after accurately recognizing locations of fixed connection words. In other words, it is necessary to notify the ACS unit in the PRML decoder of the timing when the fixed connection words appear. A configuration of the PRML decoder implementing such function will be described below.

FIG. 9 is a block diagram of a PRML decoder 70 according to the embodiment 1. The PRML decoder 70 comprises a sync detector 71, a counter 72, an ACS unit 73, the path memory 74, and a connection word determinator 75. The operation of the connection word determinator 75 will be described later. Hereinafter, other functional units will be described first.

The signals reproduced by the PRML decoder 70 are inputted into the ACS unit 73 and into the sync detector 71 simultaneously. The sync detector 71 detects the beginning of frame using the frame sync unit 60 described in FIG. 7. Since the channel bit word length is constant in fixed length modulation, the fixed connection word appears at a constant time interval. Thus the ACS unit 73 may be controlled as above at the constant time interval after detecting the beginning of frame. After the sync detector 71 detects the beginning of frame, the counter 72 counts the channel clock from that time point, and notifies to the ACS unit 73 the timing to change the behavior of the ACS unit 73. The ACS unit 73 changes the ACS behavior during a required duration (in the example of FIG. 8, from time −1 to time 2) according to the notification. The processing result of the ACS unit 73 is stored in the path memory 74.

FIG. 10 shows a simulation result of an example in which an error propagation at a channel bit word boundary is prohibited. The calculation conditions of optical responses are: spot light wavelength=405 nm; objective lens NA=0.85. Reproduction signals are calculated using convolution with respect to channel bit patterns based on optical responses calculated by optical simulations (channel bit length: 48 nm). Channel bit patterns are generated by performing, with respect to random user data sequence, fixed length modulation with the minimum run length of 1 having the above-mentioned regularity. This modulation corresponds to (1, 7;10, 18;1) RLL according to conventional expressions. Therefore, a fixed connection word is inserted for each of 18 channel bits. The PR class used for decoding is PR (1, 2, 2, 2, 1) ML. One grid of the horizontal axis in FIG. 10 corresponds to 5 channel bits or channel clocks.

The lower half of FIG. 10 shows an input waveform into an equalizer, an input waveform into a decoder, and a target waveform. The upper half of FIG. 10 shows following binary signals. (a) original channel bit pattern (NRZI format); (b) decoded result of input waveform by the PRML decoder 70 according to the embodiment 1; (c) comparing result between (a) and (b) (“1” corresponds to error); (d) decoded result using conventional PRML method; (e) comparing result between (a) and (d) (“1” corresponds to error). The vertical dotted line shows the location of the fixed connection word.

With reference to FIG. 10(e), it is understood that pileup error occurs sandwiching the channel bit word boundary if decoding is performed using conventional PRML method. This is because combination patterns that are likely to cause pileup errors exist around the channel bit word boundary. On the other hand, as can be seen from FIG. 10(c), the decoding result using the PRML decoder 70 according to the embodiment 1 does not include errors. The error at the position away from the fixed connection word by 12T is also resolved.

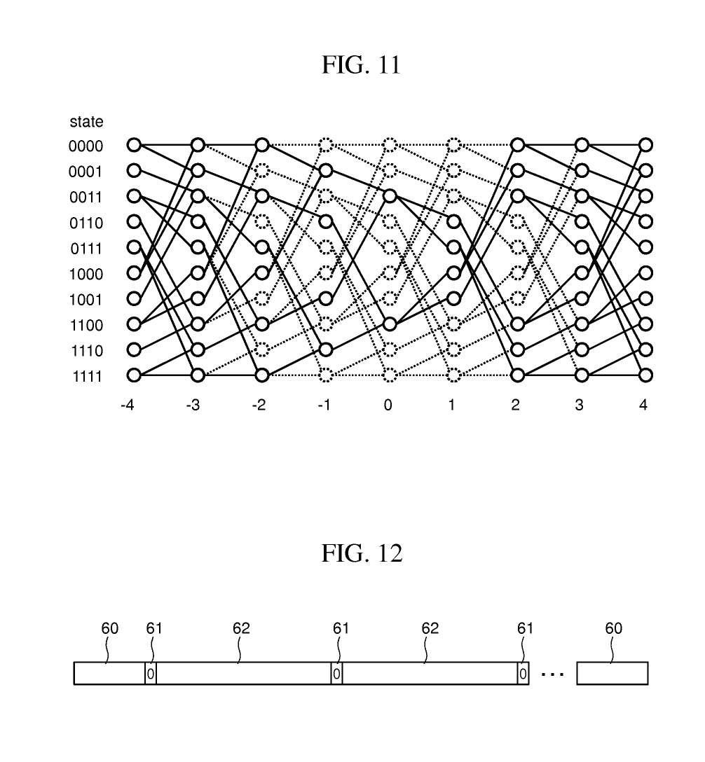

FIG. 11 shows a trellis diagram of the PRML decoder 70 around a fixed connection word when a constraint length is 5 and a minimum run-length is 1 (i.e. corresponding to the example of FIG. 10). The notation follows that of FIG. 8. In this case, it is understood that the behavior of the ACS unit 73 is required to be controlled for 6 time units from time −2 to time 3. The length of ACS unit control range M by which the behavior of the ACS unit 73 is required to be controlled is given by Equation 5 assuming that the constraint length is L.

M=2d+L−1 (Equation 5)

In the above-described examples, the behavior of the ACS unit 73 is controlled for each of time within all ranges influenced by the fixed connection word decided by the minimum run length and the constraint length. In order to achieve it, it is necessary to provide a function to change the behavior for all of states and branches in the ACS unit 73. However, that incurs complication of circuit and control. Thus in the case of FIG. 11, for example, it is contemplated to control the behavior of ACS from time 2 to time 3 only. Though the change lasts only for one time unit, all paths pass through the state corresponding to the fixed connection word at time 0 by limiting the behavior of the ACS unit 73 for that duration. The same result was acquired by decoding the same signal as that of FIG. 10 under such conditions. However, the equivalent result is not always acquired. In comparison for the decoding results of channel bit signals with length of 10⁶, if the state is controlled only for one time unit around the fixed edge, the channel bit error rate slightly degrades from 9.01×10⁻⁴ to 9.62×10⁻⁴. On the other hand, it is advantageous in that the configuration of the ACS unit 73 can be significantly simplified.

FIG. 12 is a diagram showing a frame configuration example using another connection word. Assuming decode process using PRML method, it is not necessary to use specific bit patterns as connection words. Thus in FIG. 12, the zero unit 61, i.e. “0” with a length equal to that of the minimum run length, is used as a connection word. The channel bit word 62 is generated from user data using the above-described method. Since the zero unit 61 is used as the connection word, there are at least d bits of consecutive “0”. In other words, the pattern is constrained for d time units.

If the zero unit 61 is used as the connection word, the length required for connecting channel bit words is substantially decreased than the case using fixed connection word. Therefore, especially when the minimum run length is large, the effective efficiency E* of modulation code can be more easily improved. However, in order to satisfy the maximum run length limitation, the limitation for consecutive “0” at both ends of channel bit word is stricter.

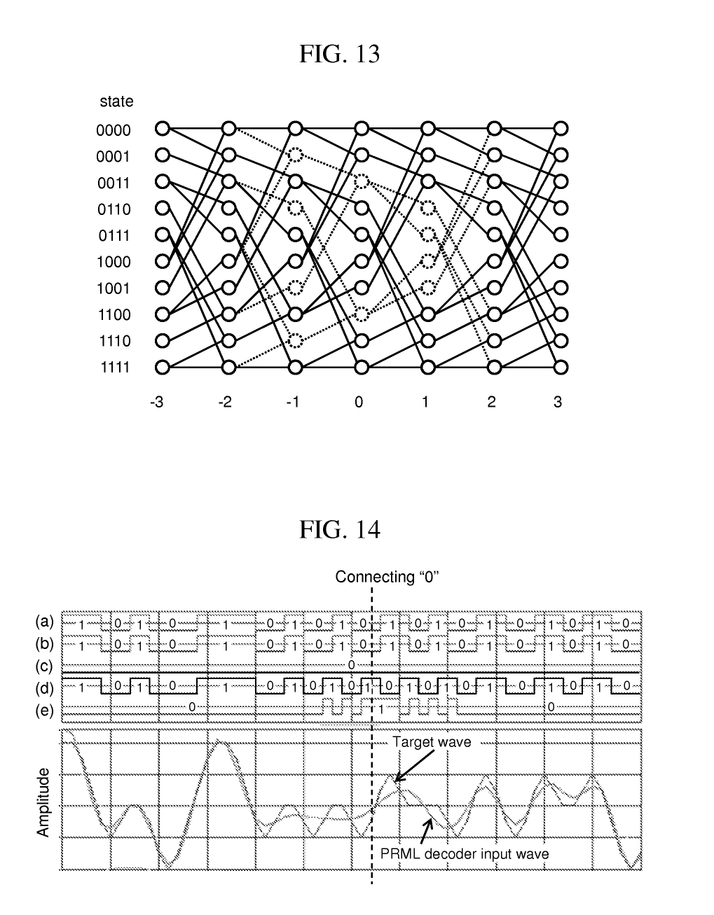

FIG. 13 shows a trellis diagram of the PRML decoder 70 when a constraint length is 5, a minimum run-length is 1, and a connection word is the zero unit 61. The notation follows that of FIG. 8. However, the time 0 is set when the zero unit (“00” or “11” in NRZI notation) is at the center of the state patterns. In this case, it is understood that the behavior of the ACS unit 73 is required to be controlled for four time units from time −1 to time 2. The length of ACS unit control range M by which the behavior of the ACS unit 73 is required to be controlled is given by Equation 6 assuming that the constraint length is L.

M=d+L−2 (Equation 6)

FIG. 14 shows a simulation result of an example in which error propagation at a channel bit word boundary is prohibited. Calculation conditions and the like are the same as those of FIG. 10. This modulation corresponds to (1, 11;10, 16;1) RLL according to conventional expressions. Therefore, a connection word of “0” is inserted for each of 16 channel bits.

The lower half of FIG. 14 shows an input waveform into a decoder and a target waveform. The upper half of FIG. 14 shows following binary signals. (a) original channel bit pattern (NRZI format); (b) decoded result of input waveform by the PRML decoder 70 according to the embodiment 1; (c) comparing result between (a) and (b) (“1” corresponds to error); (d) decoded result using conventional PRML method; (e) comparing result between (a) and (d) (“1” corresponds to error). The vertical dotted line shows the location of the connection word.

With reference to FIG. 14(e), it is understood that pileup error occurs sandwiching the channel bit word boundary if decoding is performed using conventional PRML method. This is because combination patterns that are likely to cause pileup errors exist around the channel bit word boundary. On the other hand, as can be seen from FIG. 14(c), the decoding result using the PRML decoder 70 according to the embodiment 1 does not include errors. In this way, even if using the zero unit 61 as connection words, an effect approximately equivalent to that of the case using fixed connection words can be obtained.

When using the zero unit 61 as connection words, the behavior of the ACS unit 73 may be controlled only for a part of durations (e.g. from time 1 to time 2 in FIG. 13) as in the case of using fixed connection words.

As discussed thus far, the PRML decoder 70 according to the embodiment 1 uses a fixed bit stream as a connection word between channel bit words. Accordingly, it is possible to suppress influences of pileup errors propagating into adjacent channel bit words even if fixed length code is used.

In addition, at the time when fixed connection words appear, the PRML decoder 70 according to the embodiment 1 invalidates the state and branch in the trellis diagram in the ACS unit 73 to suspend the path metric calculation, and uses the states and branches derived from the fixed connection word. This enables effectively performing decode process utilizing the fixed connection word.

### Embodiment 1

### Minimizing DSV

By using the configurations described above, it is possible to significantly suppress pileup errors in which errors propagate beyond the channel bit word boundaries. However, the above-described configurations do not consider adjustment for DSV of channel bit words. Therefore, another configuration is necessary to control DSV of channel bit words. For example, a recording area for controlling the number of inserted edges may be secured depending on DSV of adjacent channel bit words. However, such configuration may lead to decrease in linear recording density. Thus it is necessary to develop other methods.

As described above, either “1” or “0” may be used as connection words for suppressing error propagation beyond channel bit word boundaries. Hereinafter, a method will be discussed in which DSV of channel bit words is made smaller as far as possible while suppressing error propagation.

As described with reference to FIG. 1, channel bit words are described in NRZI format. In NRZI format, the signal is inverted when indicating bit “1” and is not inverted when indicating bit “0” (opposite bit patterns may be employed in some cases). Therefore, even if the bit stream before converting into NRZI format is same, the code sequence after the conversion could be opposite depending on whether the initial bit after converting into NRZI format is “0” or “1”. In other words, even the channel bit word represents same information, the code sequence (i.e. DSV) is reversed depending on whether the initial bit is “0” or “1”. This characteristic may be utilized to adjust DSV of channel bit words.

For example, if DSV of a channel bit word is biased to bit “1”, it is desirable if DSV of the next channel bit word is biased to bit “0” in order to balance DSV. Then DSV of the next channel bit word is actually calculated. If the calculated DSV is biased to bit “0”, the next channel bit word is used without modification. If the calculated DSV is polarized to bit “1”, the bit sequence of the next channel bit word is reversed while keeping the same information represented by the next channel bit word.

Considering the expression of NRZI format, in order to reverse bit sequence while keeping the same information represented by the next channel bit word, the next channel bit word may be connected by using a connection word including an odd number of bit “1”. On the other hand, when using the next channel bit word without reversing bit sequence, a connection word may be used including none of bit “1” or including an even number of bit “1”.

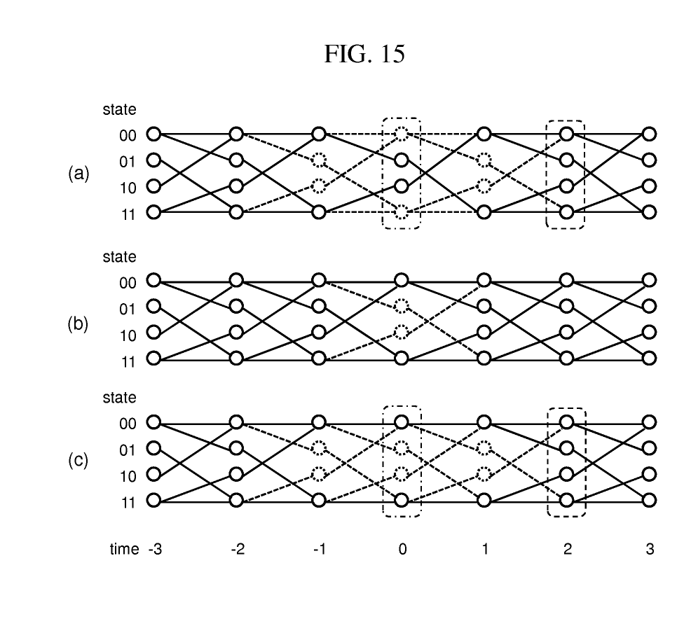

FIG. 15 is a diagram showing that paths and states on a trellis diagram are constrained according to type of connection word. For the sake of simplicity, the example assumes a minimum run length d=1 and a constraint length L=3.

FIG. 15(a) is a trellis diagram around a connection word when using “1” as the connection word (the notation follows that of FIG. 8). As can be understood from Equation 5, the states or the paths are constrained for 4 time units. FIG. 15(b) is a trellis diagram around a connection word when using “0” as the connection word. As can be understood from Equation 6, the states or the paths are constrained for 2 time units. The appearing sequences of constrained states or paths are different between FIGS. 15(a) and 15(b).

Now it is assumed that subsequent channel bit word is reversed, i.e. a connection word is used that includes an odd number of “1”. Considering the run-length limitation, an actual connection word may be “010” of length 3, for example. In that case, it is necessary depending on the bit configuration of the connection word to change the constraint about the location of “1” at both ends which is imposed on the basis of run-length limitation when generating channel bit words.

When not reversing the subsequent channel bit word, the length of connection word should be same as that of the case reversing the subsequent channel bit word. Thus “000” may be used as the connection word. FIG. 15(c) shows a trellis diagram of that case around the connection word.

When selecting the connection word in order to adjust DSV of channel bit word, another problem may be caused. As described above, in order to suppress pileup errors, it is important to identify paths and states on the trellis diagram around the connection word. Therefore, when selectively change the connection word, it is necessary to determine which one of connection words is used in the decoding process. Hereinafter, a method for determining the connection word will be described.

With reference to the center portion (time 0) of the connection word surrounded by dotted line in FIG. 15(a)(c), the valid states in the trellis diagram are separated into two types of 00/11 and 01/10, depending on whether the time corresponds to bit “1” or not. This can be utilized to statistically determine the type of connection word. Specifically, by tracing back the path after performing ACS and by inspecting which pattern is statistically included more than the other pattern, it is possible to precisely determine which type of connection word is used. Hereinafter, the sequence for determining the connection word will be described.

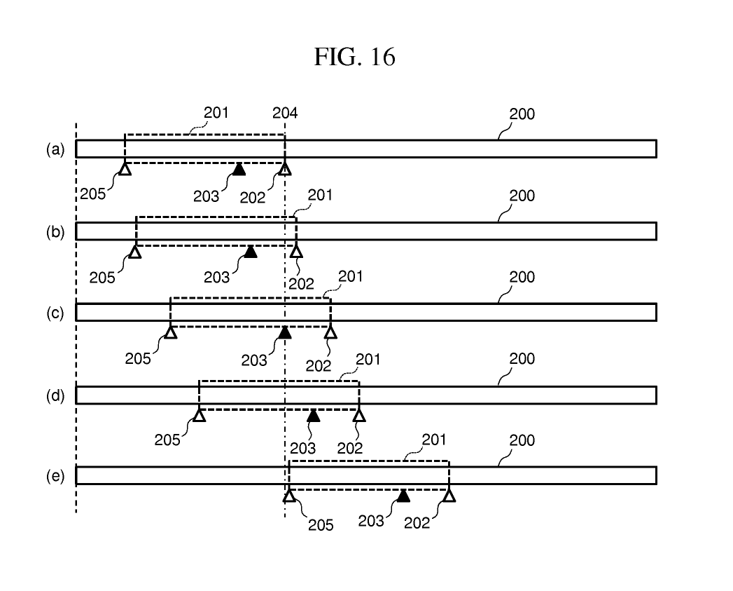

FIG. 16 is a diagram schematically showing a process where the connection word determinator 75 performs trace-back. For the sake of convenience of description, it is assumed that reproduced results of ACS for all times are stored in a virtual path memory 200 (actually in the path memory 74) with sufficient size. The progressing direction of light spot corresponds to the direction from left side to right side of FIG. 16. The center position of connection word (in the example of FIG. 15, “000” or “010”) is referred to as a center bit position 204.

The connection word determinator 75 performs trace back within the trace back region 201, thereby determining the decoded result. The connection word determinator 75 performs trace back from the trace back region right end 202 toward the trace back region left end 205, and shifts the trace back region 201 rightward by 1 time unit every time when completing the decode process for 1 time unit.

The connection word determinator 75 monitors a situation where the center bit position 204 reaches the trace back region right end 202. FIG. 16(a) shows a situation where the trace back region right end 202 has reached the center bit position 204.

FIG. 16(b) shows a situation where the center bit position 204 is between the trace back region right end 202 and the connection word determination position 203. The connection word determination position 203 is set at an appropriate position so that it is possible to acquire an integral value sufficient for determining which one of 00/11 and 01/10 is more than the other as valid states on the trellis diagram. In this period, the connection word determinator 75 sums up the number of paths passing through each of states during each trace back.

FIG. 16(c) shows a situation where the connection word determination position 203 has reached the center bit position 204. At this time, the connection word determinator 75 compares the integrated number of paths passing through each state during trace back, thereby determining which one of connection words is used. If the sum of numbers of paths passing through the state 00/11 is larger than the sum of numbers of paths passing through the state 01/10, the connection word determinator 75 determines that the connection word is “000”. Otherwise the connection word determinator 75 determines that the connection word is “010”.

FIG. 16(d) shows a situation after the connection word determination position 203 passed through the center bit position 204. In this region, the connection word determinator 75 performs trace back with a constraint of paths corresponding to the previously determined connection word. However, at the time when the connection word determinator 75 performs trace back, the ACS unit 73 has already finished ACS and the path memory 74 only stores state values that are left after the ACS process. When the connection word determinator 75 performs trace back, if it is necessary to pass through a state value discarded during ACS process in order to trace back paths derived from the previously determined connection word, the connection word determinator 75 preferentially uses paths derived from the connection word. In other words, the connection word determinator 75 performs trace back utilizing paths that are discarded during ACS process.

FIG. 16(e) shows a situation where the trace back region 201 has exited the path constraint region. At this time, the connection word determinator 75 cancels the constraint for all paths and states. The connection word determinator 75 performs decode process using normal trace back until the trace back region 201 reaches the next center bit position 204.

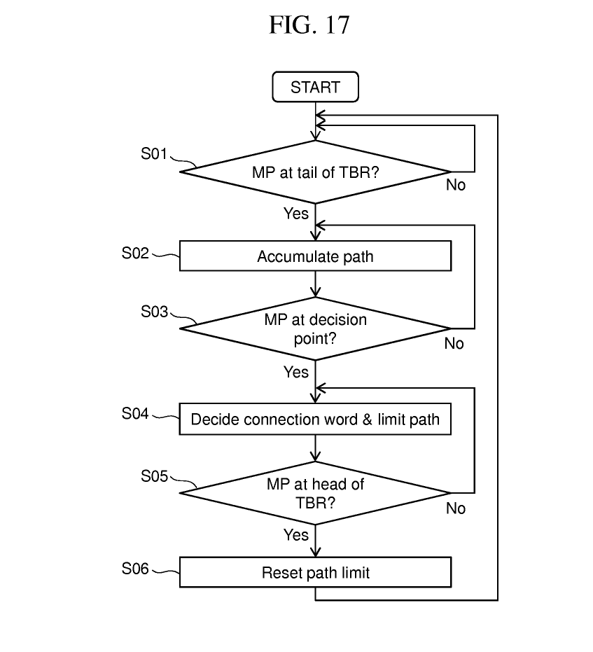

FIG. 17 is an operational flow chart of the connection word determinator 75. The connection word determinator 75 monitors a situation where the trace back region right end 202 of the trace back region 201 (in FIG. 17, referred to as TBR) reaches the center bit position 204 (in FIG. 17, referred to as MP) (S01). As described with reference to FIG. 16(b), the connection word determinator 75 sums up the number of each state passing through during trace back (S02). The connection word determinator 75 determines the type of connection word at the time (S03) described with reference to FIG. 16(c). The connection word determinator 75 performs trace back with a constraint corresponding to the connection word (S04). When reaching the state shown in FIG. 16(e) (S05), the connection word determinator 75 cancels the constraint for paths and states and then performs normal trace back until reaching the next center bit position 204 (S06).

With reference to the time 2 (dotted line) in FIG. 15(a)(c) again, both are subjected to the same path constraint. This is because the connection word “0” (NRZ format) is fixed for the time 1. It is not always necessary to perform ACS and to perform trace back with constraints for paths or for states against whole of the constraint region. Even in the example of FIG. 15, it is possible to suppress error propagations beyond channel bit boundaries by considering path constraints from the time 1 to the time 2 only, though some decrease in performance may occur. In this case, it is not necessary to identify whether the connection word is “000” or “010”. Thus it is beneficial to simplify the configuration and control of the decoder. Since the constraint length of the decoder is larger as the minimum run length of system becomes larger, the benefit above is further effective.

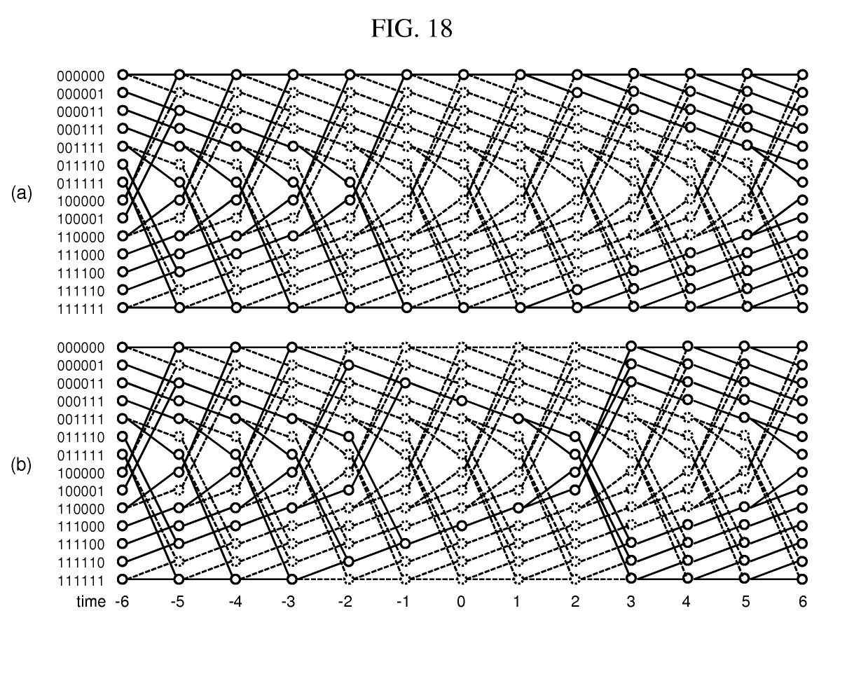

FIG. 18 is an example of trellis diagram when constraint length of decoder is long. FIG. 18 shows a trellis diagram around the connection word in which the minimum run length is 3 and the constraint length of the PRML decoder is 7. FIG. 18(a)(b) are trellis diagrams when the channel bit word is not inverted and is inverted, respectively. If it is assumed that “0” with the same length as that of the minimum run length is assigned at both ends of the bit indicating whether the channel bit word is inverted or not, the length of channel bit word is 2d+1 (in FIG. 18, the length is 7).

As can be seen from FIG. 18, almost all of state (14 states) and paths (4 paths) are sequentially constrained during 12 time units. It is necessary that the ACS unit 73 and the path memory 74 include structures that can reflect those constraints, thus the configurations thereof may be complicated. On the other hand, when imposing path constraints only at the last end of the path constraint region (in FIG. 18, from time 5 to time 6) as in the previously described example, it is obvious that only partial path constraints will be sufficient and thus the configuration of the ACS unit 73 and the like will be simplified. In addition, if paths that are derived from the connection word are more prioritized than selected results by ACS as in the previously described example, it is possible to achieve the same advantageous effect without imposing path constraints by the ACS unit 73. Thus the decoder may be further simplified. Further, as can be seen from FIG. 18(a)(b), the path constraint at the last end of the path constraint region is same for all of the connection word. Thus it is not necessary to determine the type of connection word.

Hereinafter, a condition will be discussed in which the run length constraint including the connection word is fully satisfied when the length of connection word is 2d+1 and when the connection word may be consisted of either bit “0” only or only the center bit is “1”, as in the previous example. Regarding the minimum run length limit, it is obviously unnecessary to impose constraints against channel bit words regardless of the type of connection word. Regarding maximum run length, the length of connection word is d in typical examples but is longer in this example. Therefore, it is necessary to configure the constraint rule when generating channel bit words considering a case where the connection word is all “0”. In other words, the distance from both ends of channel bit word to a bit “1” appearing firstly is floor[(k−d)/2] in the typical example. On the other hand, the distance in this example is floor[(k−2d−1)/2]. As a result, it may be necessary to change modulation parameters such as expanding the length of channel bit word.

On the other hand, if such changes in modulation parameters are not desired, the constraint rule as that of the typical example will be used. When generating channel bit word according to the constraint rule as that of the typical example, some cases may violate the maximum run length limit at a region including the connection word. In other words, a run length may appear with a maximum length of k+d+1. However, the location where such violation occurs can be predicted. In addition, in run length limited codes of high order, the absolute value of maximum run length limit is large. Thus there will not be significant effect even if a run length is extended by d+1. In other words, it is possible to use channel bit words with a length same as that of the typical example by allowing an exception of violating the maximum run length limit at a region including the connection word. This achieves avoiding decrease in effective linear recording density.

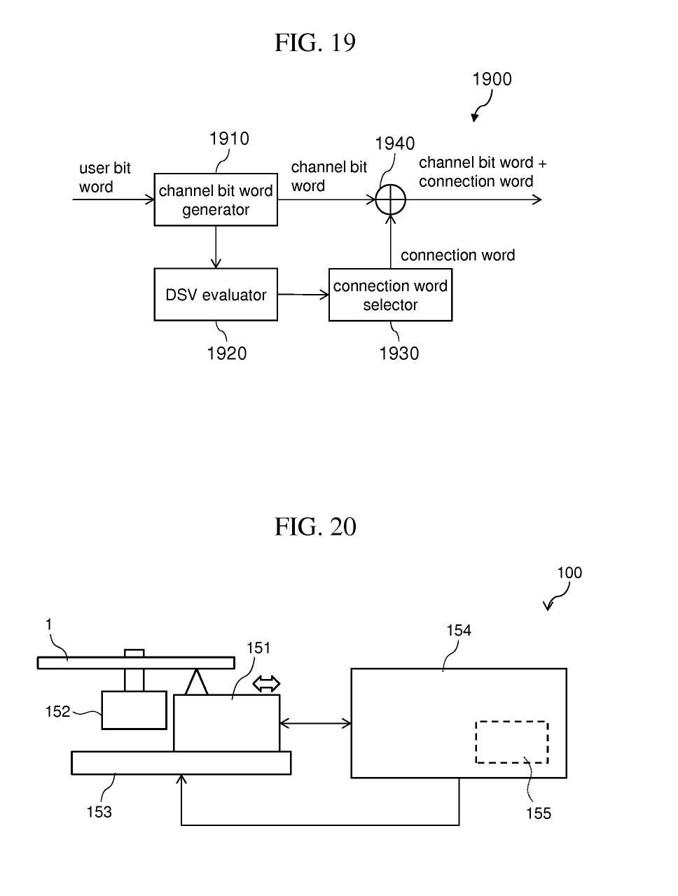

FIG. 19 is a functional block diagram of a channel bit word processor 1900 according to the embodiment 1. The channel bit word processor 1900, using user bit words as inputs, generates channel bit words of NRZI format using run length limited code with fixed length based on enumeration.

The channel bit word processor 1900 includes a channel bit word generator 1910, a DSV evaluator 1920, a connection word selector 1930, and a coupler 1940. The channel bit word generator 1910 generates the above-mentioned channel bit word using inputted user bit words. The DSV evaluator 1920 calculates DSV of consecutive channel bit words. The connection word selector 1930 selects one of connection word candidates (e.g. above-mentioned “000” or “010”). The coupler 1940 couples a channel bit word with a connection word.

The connection word selector 1920 selects one of channel bit word candidates so that the absolute value of DSV of code stream in which consecutive channel bit words and the connection word candidate are coupled is minimized. For example, the DSV evaluator 1920 calculates absolute DSV values of code stream in which two consecutive channel bit words and each of the connection word candidates are combined, respectively. The connection word selector 1920 selects a connection word candidate which achieves the minimum DSV absolute value. The number of channel bit words for evaluating DSV is not necessarily 2. For example, one of connection word candidates may be selected so that absolute DSV value of code stream in which more than 2 channel bit words and a connection word are coupled is minimized.

### Embodiment 1

### Summary

As discussed thus far, the channel bit word processor 1900 according to the embodiment 1 selects a connection word so that the DSV absolute value of code stream in which consecutive channel bit words and a connection word are coupled is minimized as far as possible. The connection word candidates include a connection word having an odd number of “1” and a candidate having 0 or an even number of “0”. Accordingly, it is possible to suppress burst errors using the above-mentioned sequence in decoding process while suppressing DSV as far as possible.

As described above, by imposing path constraints derived from connection words during a process where the connection word determinator 75 performs trace back, it is possible to achieve the same advantageous effect without imposing path constraints by the ACS unit 73. One of the path constraint imposed by the connection word determinator 75 and the path constraint imposed by the ACS unit 73 may be used, or alternatively both of them may be used. When imposing the path constraint by the connection word determinator 75 only, it is possible to simplify the configuration of the ACS unit 73.

### Embodiment 2

The embodiment 1 describes that two types of connection words may be appropriately selected depending on the DSV absolute value. However, it is possible to use 3 or more of connection word candidates may be used. An embodiment 2 of the present invention describes an example thereof.

In the embodiment 1, a connection word consisted of bit “0” only is described as an example that does not invert subsequent channel bit words. In this case, if it is necessary to keep the maximum run length limit around the connection word, some cases require changing modulation parameters. A connection word having an even number of “1” may be used as an example that does not invert subsequent channel bit words. Thus “0100010” is added into the connection word candidates and the connection word selector 1920 may select any appropriate one of the three connection word candidates.

For example, a case is assumed where a run length around the last edge of a preceding channel bit word and a run length around the front edge of a subsequent channel bit word are both long and thus the maximum run length limit is violated when using “0000000” as the connection word. In this case, the connection word selector 1920 selects “0100010” as the connection word. This connection word is same as a connection word consisted of “0” only in terms of adjusting DSV absolute value. Thus it is possible to achieve the same advantageous effect as that of the embodiment 1 while satisfying the run length limit.

### Embodiment 3

FIG. 20 is a configuration diagram of an optical disc device 100 according to an embodiment 3 of the present invention. The optical disc 1 is rotated by a spindle motor 152. An optical pickup 151 is configured by a light source used for recording and reproducing, an optical system such as an objective lens, and the like. The optical pickup 151 performs seek operation using a slider 153. A main circuit 154 instructs seek, rotation of the spindle motor, and the like. The main circuit 154 equips each of the circuits performing code modulation and demodulation described in the preceding embodiments (the channel bit processor 1900, the PRML decoder 70), a decode signal processing circuit, a processing system such as focusing and tracking feedback controller, a microprocessor, a memory, and the like. A firmware 155 controls the overall operation of the optical disc device 100. The firmware 155 is stored in a memory in the main circuit 154. The microprocessor executes it.

The present invention is not limited to the embodiments, and various modified examples are included. The embodiments are described in detail to describe the present invention in an easily understood manner, and the embodiments are not necessarily limited to the embodiments that include all configurations described above. Part of the configuration of an embodiment can be replaced by the configuration of another embodiment. The configuration of an embodiment can be added to the configuration of another embodiment. Addition, deletion, and replacement of other configurations are also possible for part of the configurations of the embodiments.

The configurations, the functions, the processing units, the processing means, etc., may be realized by hardware such as by designing part or all of the components by an integrated circuit. A processor may interpret and execute programs for realizing the functions to realize the configurations, the functions, etc., by software. Information, such as programs, tables, and files, for realizing the functions can be stored in a recording device, such as a memory, a hard disk, and an SSD (Solid State Drive), or in a recording medium, such as an IC card, an SD card, and a DVD.

### DESCRIPTION OF SYMBOLS

70 PRML decoder
71 sync detector
72 counter
73 ACS unit
74 path memory
75 connection word determinator
1900 channel bit word processor
1910 channel bit word generator
1920 DSV evaluator
1930 connection word selector
1940 coupler
100 optical disc device

What is claimed is:

1. A channel bit word processor that processes a channel bit word using a run length limited code of fixed length based on enumeration, comprising:
a channel bit word generator that generates the channel bit word of NRZI format using a user bit word;
a DSV evaluator that calculates a DSV of a plurality of consecutive ones of the channel bit words; and
a connection word selector that selects one of a plurality of connection word candidates that are candidates of connection word connecting the plurality of consecutive ones of the channel bit words,
wherein the plurality of connection word candidates includes one of the connection word candidate that includes an odd number of bit “1” in NRZ format and one of the connection word candidate that includes an even number of bit “1” in NRZ format,
and wherein the connection word selector selects one of the connection word candidates as the connection word, so that an absolute value of DSV of a code stream in which the plurality of consecutive ones of the channel bit words and the connection word are combined is minimized.

2. A PRML decoder that decodes, using PRML method, a bit frame configured by a channel bit word of NRZI format using a run length limited code of fixed length based on enumeration and a connection word between the channel bit words, comprising:
an ACS unit that calculates a path metric in PRML decode process; and
a connection word determinator that determines which one of a plurality of connection word candidates is selected as the connection word,
wherein the plurality of connection word candidates includes one of the connection word candidate that includes an odd number of bit “1” in NRZ format and one of the connection word candidate that includes an even number of bit “1” in NRZ format,
and wherein the connection word determinator determines which one of the connection word candidates is used as the connection word by: performing trace back for a predetermined period to a calculated result of the ACS unit; summing up, for each of state values of PRML decode, a frequency of the state values through which the trace back passes at a reference time corresponding to a reference bit in the connection word; and inspecting which one of the frequency of the state values is larger.

3. The PRML decoder according to claim 2,
wherein the connection word determinator inspects which one of: the frequency of the state values occurring when the reference bit is “0”; and the frequency of the state values occurring when the reference bit is “1”, is larger,
and wherein the connection word determinator determines that the connection word candidate corresponding to a larger one of the inspection is used as the connection word.

4. The PRML decoder according to claim 2,
wherein the connection word determinator, after determining which one of the connection word candidates is used as the connection word, performs the trace back using the state value derived from the determined connection word.

5. The PRML decoder according to claim 4,
wherein the connection word determinator performs the trace back, prioritizing the state value derived from the determined connection word than the state value selected by the ACS unit in calculating the path metric.

6. The PRML decoder according to claim 2 further comprising:
a sync detector that detects a frame sync mark included in the bit frame; and
and a counter that counts a duration from when the sync detector detects the frame sync mark to when an ACS unit control period in which a behavior of the ACS unit is required to be changed appears,
wherein the ACS unit specifies the ACS unit control period according to a count result by the counter,
and wherein within the specified ACS unit control period, the ACS unit calculates a path metric using a branch metric derived from a value of the connection word instead of calculating a path metric using a branch metric enumerated in accordance with path metrics of preceding times.

7. The PRML decoder according to claim 2,
wherein within the ACS unit control period, the ACS unit uses a branch metric derived from a value of the fixed connection word by invalidating a state value corresponding to the connection word and by invalidating a branch derived from the invalidated state value.

8. The PRML decoder according to claim 2,
wherein the connection word determinator specifies the ACS unit control period according to a count result by the counter,
and wherein within the specified ACS unit control period, the connection word determinator performs the trace back prioritizing a path derived from the connection word than a path selected by the ACS unit in calculating the path metric.

9. An optical information recording/reproducing device comprising a channel bit word processor that processes a channel bit word using a run length limited code of fixed length based on enumeration,
wherein the channel bit word processor comprises:
a channel bit word generator that generates the channel bit word of NRZI format using a user bit word;
a DSV evaluator that calculates a DSV of a plurality of consecutive ones of the channel bit words; and
a connection word selector that selects one of a plurality of connection word candidates that are candidates of connection word connecting the plurality of consecutive ones of the channel bit words,
wherein the plurality of connection word candidates includes one of the connection word candidate that includes an odd number of bit “1” in NRZ format and one of the connection word candidate that includes an even number of bit “1” in NRZ format,
and wherein the connection word selector selects one of the connection word candidates as the connection word, so that an absolute value of DSV of a code stream in which the plurality of consecutive ones of the channel bit words and the connection word are combined is minimized.

10. The optical information recording/reproducing device according to claim 9, comprising a PRML decoder that decodes, using PRML method, a bit frame configured by a channel bit word of NRZI format using a run length limited code of fixed length based on enumeration and a connection word between the channel bit words,
wherein the PRML decoder comprises:
an ACS unit that calculates a path metric in PRML decode process; and
a connection word determinator that determines which one of a plurality of connection word candidates is selected as the connection word,
wherein the plurality of connection word candidates includes one of the connection word candidate that includes an odd number of bit “1” in NRZ format and one of the connection word candidate that includes an even number of bit “1” in NRZ format,
and wherein the connection word determinator determines which one of the connection word candidates is used as the connection word by: performing trace back for a predetermined period to a calculated result of the ACS unit; summing up, for each of state values of PRML decode, a frequency of the state values through which the trace back passes at a reference time corresponding to a reference bit in the connection word; and inspecting which one of the frequency of the state values is larger.
